(19) United States
(12) Patent Application Publication
(10) Pub. No.: US 2017/0147772 A1
(43) Pub. Date: May 25, 2017

(54) WIRELESS PATIENT VERIFICATION

(71) Applicant: Covidien LP, Mansfield, MA (US)

(72) Inventors: CHRISTOPHER J. MEEHAN, Denver, CO (US); DANIEL LISOGURSKI, Boulder, CO (US)

(21) Appl. No.: 14/949,586

(22) Filed: Nov. 23, 2015

(51) Int. Cl. G06F 19/00; H04Q 9/00

(52) U.S. Cl. CPC G06F 19/3418; H04Q 9/00

(57) ABSTRACT

Methods, apparatuses and systems are described for associating a patient with a medical sensor. Methods may include receiving a patient identifier that is physically coupled with the patient, receiving a dynamically generated sensor identifier associated with the medical sensor, and associating the patient identifier with the sensor identifier. Methods may further include re-receiving the patient identifier after an occurrence of a disassociation event between the patient and the medical sensor, receiving an updated sensor identifier associated with the medical sensor that is different from the sensor identifier received before the disassociation event, and associating the patient identifier with the updated sensor identifier. Systems may include a medical sensor configured to collect medical data from the patient and a display unit coupled with the medical sensor and configured to display a dynamically generated sensor identifier associated with the medical sensor.

### BACKGROUND

The present disclosure relates generally to wireless patient monitoring systems and medical sensors, and more particularly to associating a medical sensor with a patient. In a medical care facility such as a hospital, a patient monitoring system including one or more medical sensors may be attached to a patient and used to monitor a variety of physiological parameters of the patient such as heart rate, blood oxygen saturation levels, respiratory rate, glucose level, etc. Conventional monitoring systems typically include one or more wires to connect the sensors to a power outlet or to a monitoring station located within the patient's hospital room. When these wired or stationary sensors are used, there is minimal risk of accidently associating the sensor with the wrong patient because the sensor is continuously attached to the patient, the sensor remains in the patient's room, the sensor is physically attached to a monitoring station within the patient's room, or some combination of these features.

If, however, the sensors are wireless, there may be an increased risk of associating a sensor with the wrong patient. The increased risk stems from the particular characteristics of wireless sensors such as their need to be recharged and their wireless pairing and data transmission capabilities. For example, when a patient is admitted to a hospital, a wireless heart rate sensor may be attached to the patient. The heart rate sensor may be initially associated with the patient such that when the sensor wirelessly transmits the heart rate data to a central station or a mobile device, the monitoring clinician knows the received medical data is associated with that particular patient.

However, because the sensor is wireless, it may have a battery source that needs to be recharged one or more times during the patient's stay, which may require removing the sensor from the patient and docking it to a charging station for example. While the first sensor is being recharged, a different wireless heart rate sensor may be attached to the patient so that the patient's heart rate is continuously monitored. Now that a different heart rate sensor has been attached to the patient, there is a risk that the new sensor will not be properly associated with the patient. For example, the central station or mobile device may still be associating the new heart rate monitor with the patient who previously wore it. There is also a risk that when the heart rate sensor being charged is placed on a different patient, the central station or mobile device will still be associating the received medical data from the sensor with the patient who originally wore it.

Another source of risk arises when a wireless sensor is wirelessly paired with the hospital network. For example, if a clinician attaches a wireless heart rate sensor to a patient and then proceeds to wirelessly pair the sensor with a mobile device, a central station, or the hospital network, the clinician may inadvertently pair with the wireless sensor worn by a nearby patient instead of the wireless sensor worn by the intended patient. Regardless of how it occurs, if a medical sensor is erroneously associated with the wrong patient, the central station or mobile device monitored by a clinician may attribute the received medical data of one patient to a different patient.

### SUMMARY

The described features generally relate to methods and devices for associating a medical sensor with a patient to reduce or eliminate the risk of accidentally associating the sensor with the wrong patient. An exemplary method described herein includes associating a patient with a medical sensor by associating a dynamically generated identifier of the sensor with an identifier of the patient. The patient identifier may be a barcode printed on a wristband, chart, electronic medical record, a biometric identifier, or some other attribute or characteristic that uniquely identifies the patient. The sensor identifier may be a barcode or some other type of machine-readable label that is dynamically generated and that uniquely identifies a particular medical sensor. The sensor identifier and the patient identifier may be scanned, photographed, sensed, or otherwise received by a mobile device that then associates the sensor identifier with the patient identifier, thereby associating the particular patient with the particular medical sensor.

In certain situations, a medical sensor may be temporarily or permanently removed from a patient and either reattached to that patient or attached to a different patient. In such cases, to avoid accidentally associating the medical sensor with the wrong patient, the sensor identifier may be updated or may be completely regenerated such that a new association between the medical sensor and the patient is established. In accordance with methods described herein, a medical sensor may be associated with a patient by re-receiving the patient identifier, receiving an updated sensor identifier, and associating the patient identifier with the updated sensor identifier.

Embodiments of systems and devices for associating a patient with a medical sensor are also described. In accordance with certain aspects, a system includes a medical sensor configured to collect medical data from the patient and a display unit coupled with the medical sensor and configured to display a dynamically generated sensor identifier associated with the medical sensor.

Certain embodiments of the present disclosure may include some, all, or none of the above advantages or features. One or more other technical advantages or features may be readily apparent to those skilled in the art from the figures, descriptions, and claims included herein. Moreover, while specific advantages or features have been enumerated above, various embodiments may include all, some, or none of the enumerated advantages or features.

Further scope of the applicability of the described methods and apparatuses will become apparent from the following detailed description, claims, and drawings. The detailed description and specific examples are given by way of illustration only, since various changes and modifications within the spirit and scope of the description will become apparent to those skilled in the art.

### BRIEF DESCRIPTION OF THE DRAWINGS

A further understanding of the nature and advantages of the embodiments may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is a system diagram of an example of a wireless sensor system in accordance with various embodiments;

FIG. 2 is a system diagram of an example of a wireless sensor system in accordance with various embodiments;

FIG. 3 is a block diagram of an example of an apparatus in accordance with various embodiments;

FIG. 4 is a block diagram of an example of an apparatus in accordance with various embodiments;

FIG. 5 is a block diagram of an example of an apparatus in accordance with various embodiments;

FIG. 6 is a block diagram of an example of an apparatus in accordance with various embodiments;

FIG. 7 is a block diagram of an example of an apparatus in accordance with various embodiments;

FIG. 8 is a flowchart of a method for associating a patient with a medical sensor in accordance with various embodiments;

FIG. 9 is a flowchart of a method for associating a patient with a medical sensor in accordance with various embodiments; and

FIG. 10 is a flowchart of a method for associating a patient with a medical sensor in accordance with various embodiments.

### DETAILED DESCRIPTION

The use of wireless sensors and monitoring systems in a hospital setting may increase the risk of accidentally associating wirelessly transmitted medical data with the wrong patient. For example, a wireless sensor may be associated with the wrong patient during the initial wireless pairing procedure because a clinician may accidently pair with a nearby sensor instead of the intended sensor. In addition, a wireless sensor may be initially associated with the correct patient, but may later become associated with the wrong patient because the sensor was moved from one patient to another.

In accordance with various embodiments described herein, a medical sensor may include one or more dynamically generated identifiers that a clinician can visualize and use to associate the patient with the intended medical sensor during the initial association and wireless pairing procedure. Having a visual identifier of the sensor may allow the clinician to quickly and accurately associate the patient with the intended medical sensor as opposed to accidently pairing with a nearby sensor. Moreover, the dynamically generated identifier may be configured to automatically update or regenerate each time the sensor is removed from a patient and placed on a different patient, thereby reducing the risk of associating the medical sensor with the patient who previously wore it. In some embodiments, a medical sensor may display a sequence of sensor identifiers, at least one of which is dynamically generated. For example, a first two-dimensional bar code may contain fixed information about the device, a second dynamic barcode may contain information about the sensor's current association with a patient and a third dynamic barcode may display patient status information and received wireless signal strength and/or battery level. Each sensor identifier may be in a different format.

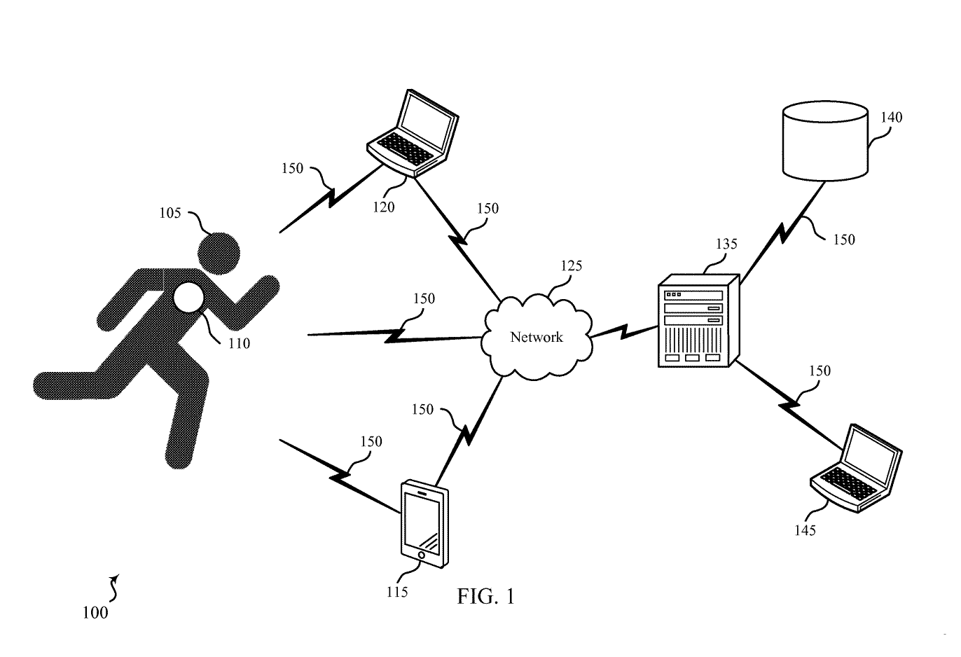

With reference to FIG. 1, an example of a wireless patient monitoring system 100 is illustrated in accordance with various embodiments of the present disclosure. The system 100 includes a patient 105 wearing, carrying, or otherwise physically coupled with a sensor unit 110. Although a single sensor unit 110 is shown, multiple sensor units 110 may be worn by the patient 105. The patient 105 may be a patient in a hospital, nursing home, home care, or other medical care facility. The sensor unit 110 may transmit signals via wireless communications links 150 to local computing devices 115, 120 or to a network 125.

Local computing device 115 may be a wireless device such as a tablet, cellular phone, PDA, dedicated receiver or other similar device or a spatially distributed network of devices configured to receive signals from the sensor unit 110. Local computing device 120 may be a wireless laptop computer or mobile computer station also configured to receive signals from the sensor unit 110. In accordance with various embodiments, at least one of the local computing devices 115, 120 may be configured to scan, photograph, sense, capture, or otherwise receive a unique identifier of the patient 105 and a unique identifier of the sensor unit 110 worn by the patient 105. In some embodiments, the unique sensor identifier may be scanned for pairing purposes by a dedicated device which is not also used as a wireless receiver for patient data, for example the clinician's tablet or cell phone. The local computing devices 115, 120 may be in communication with a central station 135 via network 125.

The sensor unit 110 may also communicate directly with the central station 135 via the network 125. The central station 135 may be a server or a nurse's station located within the hospital or in a remote location. The central station 135 may be in further communication with one or more remote computing devices 145, thus allowing a clinician to remotely monitor the patient 105. The central station 135 may also be in communication with various remote databases 140 where the collected data may be stored.

The sensor unit 110 may include one or more sensors configured to collect a variety of physiological parameters as well as information related to the location and movement of the patient 105. For example, the sensor unit 110 may include a pulse oximetry (SpO2) sensor, a heart rate sensor, a blood pressure sensor, an electrocardiogram (ECG) sensor, a respiratory rate sensor, a glucose level sensor, a body temperature sensor, an accelerometer, a global positioning sensor, a sensor which triangulates position from multiple local computing devices 115, 120, and any other sensor configured to collect physiological, location, or motion data. The sensor unit 110 may be physically coupled with the patient 105 in a variety of ways depending on the data being collected. For example, the sensor unit 110 may be coupled to the user's chest, worn around the user's wrist, or attached to the user's finger. The data collected by the sensor unit 110 may be wirelessly conveyed to either the local computing devices 115, 120 or to the remote computing device 145 (via the network 125 and central station 135). Data transmission may occur via, for example, frequencies appropriate for a personal area network (such as Bluetooth® or IR communications) or local or wide area network frequencies such as radio frequencies specified by the IEEE 802.15.4 standard.

In accordance with various embodiments, methods and apparatuses are described for associating a sensor unit 110 with a patient 105. As described in detail below, the association may include receiving, at any of local computing devices 115, 120, remote computing device 145, and/or central station 135, a unique identifier of the patient 105 and a unique identifier of the sensor unit 110 worn by the patient 105, and then associating the patient identifier with the sensor identifier. In accordance with various embodiments, the sensor identifier is dynamically generated and may be updated or regenerated either automatically or in response to an action taken by the patient 105 or a clinician.

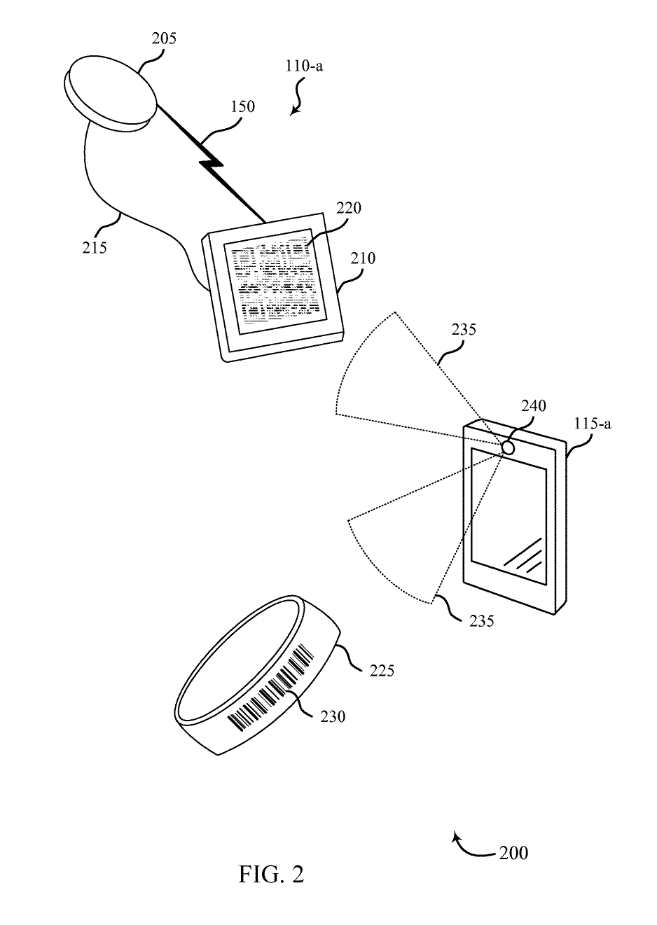

Turning to FIG. 2, a wireless patient monitoring system 200 is illustrated in accordance with various embodiments of the present disclosure. The patient monitoring system 200 includes a sensor unit 110-a, which may be an example of sensor unit 110 described with reference to FIG. 1. Sensor unit 110-a may include a medical sensor 205 and a display unit 210. The sensor 205 may be communicatively coupled with the display unit 210 via a wireless communication link 150 and/or a wired connection 215. In some embodiments, the sensor 205 and display unit 210 are combined into a single apparatus that may be worn or otherwise physically attached to the patient 105. Alternatively, the sensor 205 may be attached to the patient 105 at one location (e.g., on the chest or around a finger), whereas the display unit 210 may be attached at another location that is easier to access or visualize (e.g., around the wrist or on the hospital bed).

The sensor 205 may be any type of sensor configured to sense physiological, motion, or location data from a patient 105 including but not limited to pulse oximetry (SpO2) data, heart rate, blood pressure, body temperature, electrocardiogram (ECG) activity, respiratory rate, glucose level, acceleration, and/or a global positioning. The sensor 205 may include a dedicated battery or other rechargeable power source. Alternatively, the sensor 205 may be electrically coupled with a power source of the display unit 210 or some other power source coupled with the patient 105.

The display unit 210 may include a screen for displaying information related to the sensor 205, the display unit 210, and/or the patient 105 in human-readable or machine-readable format. In some examples, the display unit 210 includes a liquid crystal display (LCD) screen or a light-emitting diode (LED/OLED) screen. The display unit 210 may include a dedicated battery or other rechargeable power source. In other embodiments, the display unit 210 may be electrically coupled with a power source of the sensor 205 or some other power source coupled with the patient 105. The display unit 210 may be configured to continuously display information or may instead be configured to display information periodically and/or in response to some action taken by the patient 105 or a clinician. For example, the display unit 210 may automatically display information when the sensor 205 is powered on.

In accordance with various aspects of the present disclosure, the display unit 210 is configured to display a sensor identifier 220. The sensor identifier 220 may be dynamically generated, meaning that instead of being static or permanent, the sensor identifier 220 can be modified, changed, or updated. As discussed in greater detail below, the sensor identifier 220 may be updated or regenerated based on an event such as the sensor 205 being removed from the patient 105. In general, the sensor identifier 220 uniquely identifies a particular sensor 205. For example, the sensor identifier 220 may encode a numerical identifier that is unique to the sensor 205. As described in more detail below, additional information may be encoded into the sensor identifier 220 such as a signal or battery level of the sensor 205, wireless pairing information of the sensor 205, a security password or Bluetooth® advertising information, or medical data being sensed by the sensor 205. The sensor identifier 220 may be a machine-readable optical label. In some examples, the sensor identifier 220 is a barcode such as a one-dimensional barcode or a two-dimensional barcode. In certain embodiments, the sensor identifier 220 is a quick-response (QR) barcode. In yet other embodiments, the sensor identifier 220 is a dynamic optical label, meaning that the optical label is continuously changing as it is being scanned or otherwise received or decoded. A dynamic optical label may change randomly or may include a repeating sequence of images or labels.

Referring still to FIG. 2, the system 200 may also include a wrist band 225 that includes a patient identifier 230. The wrist band 225 may be given to a patient 105 when they are admitted to the hospital (e.g., during triage) for identification purposes. The patient identifier 230 uniquely identifies a particular patient 105 during their entire hospital stay and may be static or permanent throughout the stay. As illustrated in FIG. 2, the patient identifier 230 may be printed onto a band 225, tag, or other similar label and then physically attached to the patient 105 around their wrist for example. In other examples, the patient identifier 230 may be printed on a patient chart or other medical record associated with the patient 105. Alternatively, the patient identifier 230 may be displayed from a screen similar to display unit 210 or some additional display unit worn by the patient. In such cases, the patient identifier 230 may be any type of readable identifier including, but not limited to, a machine-readable optical label such as a barcode, a printed name, a printed number, or any combination of these features. In other examples, the patient identifier 230 is a physical attribute or characteristic unique to the particular patient 105 such as a biometric identifier. Examples of biometric identifiers include, but are not limited to, a fingerprint, facial recognition, DNA, iris or retina recognition, and palm vein or palm print recognition.

System 200 may also include a local computing device 115-a, which may be an example of local computing device 115 described with reference to FIG. 1. In some embodiments, local computing device 115-a is a wireless tablet, cellular phone, or scanner that is carried by a clinician around the hospital, docked at a central station, or left in the patient's room. The local computing device 115-a may include a sensor 240 that is capable of reading, scanning, capturing, sensing, or otherwise receiving the sensor identifier 220 and/or the patient identifier 230. The sensor 240 may be an optical sensor such as a camera or scanner configured to scan or otherwise read a machine-readable optical label such as a barcode. The sensor 240 may also be configured to scan or otherwise recognize one or more biometric identifiers of the patient 105. In other examples, the sensor 240 is configured for near field communication (NFC). Although a single sensor 240 is illustrated, the local computing device 115-a may include multiple sensors 240 configured for reading different types of identifiers. For example, local computing device 115-a may include a first sensor 240 configured for scanning a barcode, and a second sensor 240 configured for identifying a biometric identifier.

In accordance with various embodiments, a clinician may associate a particular sensor 205 with a particular patient 105 by associating the sensor identifier 220 with the patient identifier 230. For example, when the patient 105 is admitted to the hospital, the patient 105 may be given a wristband 225 that includes a patient identifier 230 unique to that patient 105. A sensor 205 may then be attached to the patient 105 for purpose of remote patient monitoring. Upon attaching the sensor 205 to the patient 105, the display unit 210 may generate and display a unique sensor identifier 220 that identifies the particular sensor 205 being attached to the patient 105. As described in detail below, the display unit 210 may be configured to automatically generate the sensor identifier 220 after sensing that the sensor 205 has been attached to the patient 105. Alternatively, the display unit 210 may generate the sensor identifier 220 in response to some action taken by the clinician such as powering on the sensor 205 or pressing one or more buttons on the display unit 210 or sensor 205.

Once the display unit 210 displays the sensor identifier 220, the clinician may scan 235 or otherwise receive the sensor identifier 220 with the local computing device 115-a. Once the sensor identifier 220 has been received by the local computing device 115-a, the clinician may then scan 235 or otherwise receive the patient identifier 230 that is physically coupled with the patient 105. Alternatively, the clinician may scan the patient identifier 230 and then scan the sensor identifier 220. Regardless of the order, once both the patient identifier 230 and the sensor identifier 220 have been received by the local computing device 115-a, the local computing device 115-a may associate the two identifiers, thereby associating the particular sensor 205 with the particular patient 105. This association between the sensor identifier 220 and the patient identifier 230 may be stored locally on the local computing device 115-a. Accordingly, when the sensor 205 wirelessly transmits medical data to the local computing device 115-a, the clinician will know which patient 105 is associated with the received medical data. Additionally or alternatively, the local computing device 115-a may wirelessly transmit, via the network 125, the association between the sensor identifier 220 and the patient identifier 230 to a central station 135, a remote database 140, and/or one or more additional local computing devices 115, 120 or remote computing devices 145 such that clinicians monitoring one of these devices will know which patient 105 is associated with the received medical data.

This initial association process may be repeated for additional sensors 205 worn by the patient 105. In some examples, display unit 210 is communicatively coupled with multiple sensors 205 worn by the patient. In such examples, the display unit 210 is configured to display a unique sensor identifier 220 for each of the sensors 205. Accordingly, once the initial association is completed for a first sensor 205 worn by the patient 105, the display unit 210 may generate a different sensor identifier 220 associated with a second sensor 205 worn by the patient 105. The clinician may then associate the second sensor 205 with the patient 105 by repeating the associating process of receiving the patient identifier 230, receiving the sensor identifier 220 corresponding to the second sensor 205, and then associating the two identifiers. This process may be repeated for any number of sensors 205 worn by the patient 105.

Once a particular sensor 205 is associated with a particular patient 105, this association may remain throughout the entire duration of the patient's hospital visit. However, as described in detail below, the sensor identifier 220 corresponding to a particular sensor 205 may be changed, updated, or re-generated either automatically or in response to some action taken by the patient 105 or a clinician. After the sensor identifier 220 corresponding to a particular sensor 205 has changed, the original association between the sensor 205 and the patient 105 may be automatically disassociated. To re-associate the sensor 205 with the patient 105, the clinician may repeat the steps of receiving the patient identifier 230, receiving the updated sensor identifier 220, and then associating the two identifiers to re-associate the patient 105 with the sensor 205.

In some examples, physically removing the sensor 205 from the patient 105 may cause the sensor identifier 220 to be updated or regenerated. Because the sensor 205 and/or the display unit 210 of the sensor unit 110-a may be powered by a battery or other rechargeable power source, the sensor unit 110-a will need to be recharged periodically by docking the sensor unit 110-a or the battery to a charging station or by plugging the sensor unit 110-a into a wall outlet, which may require physically removing the sensor unit 110-a from the patient 105 and/or removing the battery pack from the sensor unit 110-a. Physically removing the sensor unit 110-a from the patient 105 may be referred to as a disassociation event. As described above, once the sensor unit 110-a is removed from a patient 105 or otherwise disassociated from the patient 105, there is a risk that the sensor unit 110-a will be attached to a different patient 105 while the central station 135 or local computing devices 115, 120 are still associating the sensor unit 110-a with the original patient 105. To reduce or eliminate this risk, the display unit 210 may be configured to automatically update or generate a totally new sensor identifier 220 that uniquely identifies the sensor 205 upon the occurrence of a disassociation event. Therefore, when the sensor unit 110-a is attached to a new patient 105, the display unit 210 will display a sensor identifier 220 that is different from the sensor identifier 220 that was displayed before the disassociation event. The updated sensor identifier 220 may sever the original association between the sensor unit 110-a and the original patient 105. Even if the sensor unit 110-a is re-attached to the original patient 105, the clinician may have to re-associate the sensor unit 110-a with the patient 105 using the updated sensor identifier 220.

The power level of the sensor unit 110-a dropping below a predetermined threshold or removing the rechargeable power source from the sensor unit 110-a to be recharged may be additional examples of disassociation events. In such situations, the sensor unit 110-a may be configured to generate a new or updated sensor identifier 220. Additionally or alternatively, a signal level of the sensor unit 110-a dropping below a predetermined threshold or pressing one or more buttons on the sensor unit 110-a to disassociate the sensor unit 110-a from the patient 105 may be considered disassociation events.

It may be appreciated that for certain disassociation events, referred to herein as temporary disassociation events, it may be desirable to maintain the sensor identifier 220 and the original association between the sensor unit 110-a and the patient 105 instead of automatically disassociating the sensor unit 110-a from the patient 105 and generating a new sensor identifier 220. For example, if the battery pack of a sensor unit 110-a is removed and immediately replaced with a charged battery pack, it may be cumbersome for the clinician to have to re-associate the sensor unit 110-a with the patient 105, as the risk of erroneous association may be small in such a scenario. Another example is if the sensor unit 110-a loses its wireless signal connection momentarily, but then quickly regains it. In this situation too, it may be unnecessary to regenerate a new sensor identifier 220 and re-associate the sensor unit 110-a with the patient 105. Therefore, in accordance with various embodiments, the sensor unit 110-a may be configured to maintain its association with a patient 105 in the event of a temporary disassociation event to reduce unnecessary effort by a clinician to re-associate the sensor unit 110-a with the same patient 105 as before the temporary disassociation event. As described in greater detail below, the sensor unit 110-a may perform one or more verification procedures to ensure that it is still physically attached to the same patient 105 after the temporary disassociation event as before. In some examples, the sensor unit 110-a may compare one or more physiological parameters of the patient 105 before and after the temporary disassociation event such as an ECG reading, a plethysmograph reading, a pulse reading, or any combination of these or other physiological parameters.

In some examples, other information in addition to identification information may be encoded within the sensor identifier 220. For example, the sensor identifier 220 may include wireless pairing information such as a security password or Bluetooth® advertising information that a local computing device 115-a may use to ensure that it is wirelessly pairing with the correct sensor unit 110-a (as opposed to a nearby sensor unit 110-a attached to a different patient 105). The sensor identifier 220 may also be configured to encode information relating to the status of the sensor 205, the status of the display unit 210, or the medical data being collected by the sensor 205. For example, the sensor identifier 220 may encode the current battery level of the sensor 205 and/or the display unit 210. Additionally or alternatively, the sensor identifier 220 may encode the current signal strength level of the sensor 205 and/or the display unit 210. In yet other examples, the sensor identifier 220 may encode the current or past medical data being collected from the sensor 205. For example, if the sensor 205 is a heart rate sensor, the sensor identifier 220 may encode the current heart rate of the patient 105, a recent trend in the heart rate, the maximum, minimum, or average heart rate value for a particular time period, or any other data related to the collected medical data.

In accordance with certain examples, the display unit 210 may be configured to display the sensor identifier 220 in the form of a blinking LED light. Similar to a barcode or other machine-readable medium, information may be encoded in the timing, color sequence, and/or intensity of the blinking LED light. For example, a unique identification of a particular sensor 205, current power or signal strength of the sensor unit 110-a, and/or current or past medical data collected by the sensor 205 may be encoded within the sensor identifier 220 in the form of a blinking LED light. In such embodiments, information encoded within the sensor identifier 220 may be captured or otherwise received by any of local computing devices 115, 120 and/or surveillance cameras or similar stationary monitoring sensors located throughout the medical care facility.

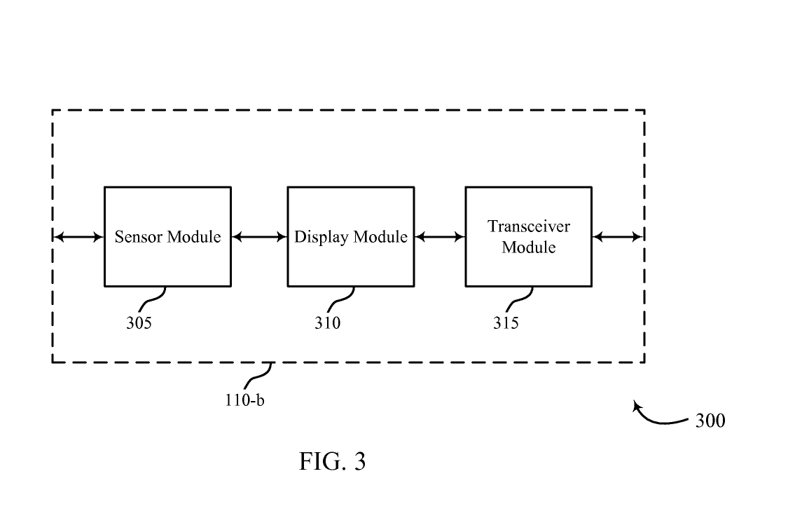

With reference to FIG. 3, a block diagram 300 that includes a sensor unit 110-b, which may be an example of one or more aspects of any sensor unit 110 described with reference to FIGS. 1-2, is illustrated in accordance with various aspects of the present disclosure. In some embodiments, the sensor unit 110-b includes a sensor module 305, a display module 310, and a transceiver module 315. Each of the modules 305, 310, 315, may be positioned externally to sensor unit 110-b and may communicate with sensor unit 110-b via wired or wireless communication links. Additionally or alternatively, one or more of the modules 305, 310, 315 may be components of the sensor unit 110-b. Each of these components may be in communication with each other directly or indirectly.

The components or modules of the sensor unit 110-b may, individually or collectively, be implemented using one or more application-specific integrated circuits (ASICs) adapted to perform some or all of the applicable functions in hardware. Alternatively, the functions may be performed by one or more other processing units (or cores) such as a microcontroller, microprocessor or digital signal processor, on one or more integrated circuits. In other examples, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions embodied in a memory, formatted to be executed by one or more general or application-specific processors.

The sensor module 305 may include circuitry, logic, hardware and/or software for collecting and processing the data streams received from one or more sensors 205. The sensor module 305 may include filters, analog-to-digital converters and other digital signal processing units. Data processed by the sensor module 305 may be stored in a buffer, for example. Sensor module 305 may include any combination of physiological sensing components, including, for example, heart rate monitors, respiration monitors, blood pressure monitors, blood oxygen concentration monitors, glucose level monitors, pulse monitors, orientation monitors, accelerometers, temperature monitors, global positioning sensors, force monitors, and the like.

Data streams processed by the sensor module 305 may then be communicated to display module 310. The display module 310 may be operable to encode and/or display a dynamically generated sensor identifier 220 associated with a particular sensor 205. The display module 310 may be a component of or may be in communication with a display unit 210 as described in FIG. 2.

The transceiver module 315 may be operable to receive data streams from the sensor module 305 directly and/or indirectly through the display module 310. The transceiver module 315 is also operable to send and/or receive other signals between the sensor unit 110-b and local computing devices 115, 120 or other remote computing devices 145 or central stations 135 via the network 125. For example, the transceiver module 315 may receive data streams from the sensor module 305 related to sensed data from one or more sensors 205 and transmit these data streams to local computing devices 115, 120, remote computing devices 145, or to a central station 135 via the network 125 for remote monitoring of the patient 105. The transceiver module 315 may include wired and/or wireless connectors. For example, in some embodiments, the sensor unit 110-b may operate within a wired or wireless sensor network, and may communicate with the local computing devices 115, 120 and/or remote computing device 145 using either a wired or wireless network. The transceiver module 315 may be a wireless network interface controller (“NIC”), Bluetooth® controller, IR communication controller, ZigBee® controller and/or the like.

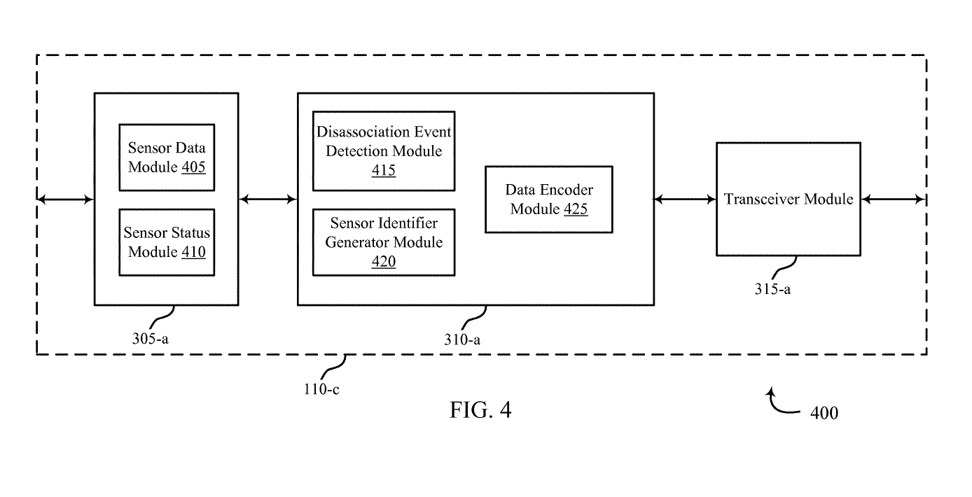

Turning to FIG. 4, a block diagram 400 that includes a sensor unit 110-c, which may be an example of one or more aspects of any sensor unit 110 described with reference to FIGS. 1-3, is illustrated in accordance with various aspects of the present disclosure. Sensor unit 110-c may include a sensor module 305-a, a display module 310-a, and a transceiver module 315-a, which may be examples of sensor module 305, display module 310, and transceiver module 315 described with reference to FIG. 3. Each of these modules may be in communication with each other, and one or more of the modules may be positioned outside of sensor unit 110-c. Alternatively, some or all of the modules may be components of the sensor unit 110-c.

In some examples, the sensor module 305-a includes sensor data module 405 and a sensor status module 410. The sensor data module 405 may include circuitry, logic, hardware and/or software for collecting and processing the data streams received from one or more sensors 205. For example, the sensor data module 405 may collect medical data from a sensor 205 and send the data to display module 310-a and/or to transceiver module 315-a. In some examples, the sensor data module 405 will continuously collect and process medical data from one or more sensors 205. Alternatively, the sensor data module 405 may collect data periodically or send information related to past collected data such as recent maximum or minimum values, trend information, or averages. The sensor data module 405 may also store medical data in memory for later retrieval and analysis as in the case of comparing medical data of a patient 105 before and after a temporary disassociation event.

The sensor status module 410 may include circuitry, logic, hardware and/or software for determining one or more statuses or characteristics of the sensor module 305-a, a sensor 205, and or the sensor unit 110-a. For example, the sensor status module 410 may determine the current battery level or current signal strength of the sensor unit 110-c and may transmit that information to the display module 310-a and/or the transceiver module 315-a. The sensor status module 410 may also be operable to detect whether the sensor unit 110-c is physically coupled with a patient 105 and whether the sensor unit 110-c is actively collecting medical data. As described in greater detail below, the information obtained and transmitted by the sensor status module 410 may be used by the display module 310-a in generating and encoding a sensor identifier 220.

In some examples, the display module 310-a includes a disassociation event detection module 415, a sensor identifier generator module 420, and a data encoder module 425. Each of these modules 415, 420, and 425 may be in direct or indirect communication with each other and with sensor module 305-a and transceiver module 315-a.

In general, the disassociation event detection module 415 may include circuitry, logic, hardware and/or software for detecting a disassociation event between aspects of the sensor unit 110-c, such as a sensor 205, and the patient 105. For example, a disassociation event may include physically removing aspects of the sensor unit 110-c from the patient 105. In such an event, the disassociation event detection module 415 may send a signal to the sensor identifier generator module 420, the encoder module 425, and/or the transceiver module 315-a indicating the occurrence of a disassociation event. In other embodiments, if the sensor status module 410 detects that the battery level or signal strength of the sensor unit 110-c falls below a predetermined threshold, the disassociation event detection module 415 may determine this to be a disassociation event and send a message to the other modules or components accordingly. Additionally or alternatively, the sensor unit 110-c may include one or more buttons that when pressed by a clinician indicate to the disassociation event detection module 415 that the sensor unit 110-c is being manually disassociated from the patient 105. In any case, when the disassociation event detection module 415 detects a disassociation event, it may send a signal to the sensor identifier generator module 420 to update or regenerate a sensor identifier 220.

In accordance with various embodiments, the disassociation event detection module 415 may, in the case of a temporary disassociation event, instruct the sensor identifier generator module 420 to not update or regenerate the sensor identifier 220. Examples of a temporary disassociation event include, but are not limited to, replacing a battery pack of the sensor unit 110-c, the sensor unit 110-c momentarily losing signal or connection with the network 125, or replacing a lead or other component of the sensor unit 110-c. Regardless of the example, in the case of a temporary disassociation event, the sensor unit 110-c or the sensor 205 is likely still physically attached to the same patient 105 as before the disassociation event, and the risk of associating the sensor unit 110-c with the wrong patient 105 is therefore small. Accordingly, if the disassociation event detection module 415 detects a temporary disassociation event, the original sensor identifier 220 may remain unchanged as well as the association between the sensor unit 110-c and the patient 105.

In some examples, the disassociation event detection module 415 may perform one or more verification procedures to ensure that the sensor unit 110-c and/or the sensor 205 is still attached to the same patient 105 as before the temporary disassociation event. An example of a verification procedure may include comparing one or more physiological parameters of the patient 105 before and after the temporary disassociation event by comparing stored medical data in the sensor data module 405 to current collected data from the sensor data module 405. Other examples of verification procedures include, but are not limited to, a clinician or patient 105 entering a passcode or pressing a series of buttons on the sensor unit 110-c, comparing a biometric identifier of the patient 105, or any other procedure that ensures the patient 105 coupled with the sensor unit 110-c is the same patient 105 as before the temporary disassociation event.

The sensor identifier generator module 420 may include circuitry, logic, hardware and/or software for dynamically generating a sensor identifier 220 that identifies a particular sensor 205. The sensor identifier generator module 420 may be operable to automatically generate a sensor identifier 220 and/or may be configured to generate a sensor identifier 220 in response to some action taken by a clinician or by the patient 105. For example, the sensor identifier generator module 420 may be configured to generate a sensor identifier 220 only after the sensor status module 410 determines that the sensor 205 has been physically attached to a patient 105. Additionally or alternatively, the sensor identifier generator module 420 may be configured to generate an updated or totally new sensor identifier 220 after the disassociation event detection module 415 detects an occurrence of a disassociation event.

The data encoder module 425 may include circuitry, logic, hardware and/or software for encoding information received from the sensor data module 405, the sensor status module 410, the disassociation event detection module 415, and/or the sensor identifier generator module 420 into the sensor identifier 220. In accordance with various embodiments, the data encoder module 425 is configured to receive a dynamically generated sensor identifier 220 from the sensor identifier generator module 420 and encode the sensor identifier 220 into a particular format for display by the display module 310-a. In some examples, the data encoder module 425 encodes the sensor identifier 220 into a machine-readable optical label, such as a barcode. The data encoder module 425 may also be operable to encode medical data collected by the sensor data module 405 into the sensor identifier 220. In yet other embodiments, the data encoder module 425 may be configured to encode information related to the status of the sensor 205 as detected by the sensor status module 410. In addition, the data encoder module 425 may be configured to encode wireless pairing information such as a security password or Bluetooth® advertising information into the sensor identifier 220 that instructs a wireless device, such as local computing devices 115, 120 how to wirelessly pair with the sensor unit 110-c. If more than one sensor 205 is attached to the patient 105, the data encoder module 425 may also encode this information into the sensor identifier 220.

In some examples, the data encoder module 425 encodes information into the sensor identifier 220 in the form of a blinking LED light. The data encoder module 425 may manipulate the timing, color sequence, and/or intensity of the light to encode information received from the sensor data module 405, the sensor status module 410, the disassociation event detection module 415, and/or the sensor identifier generator module 420.

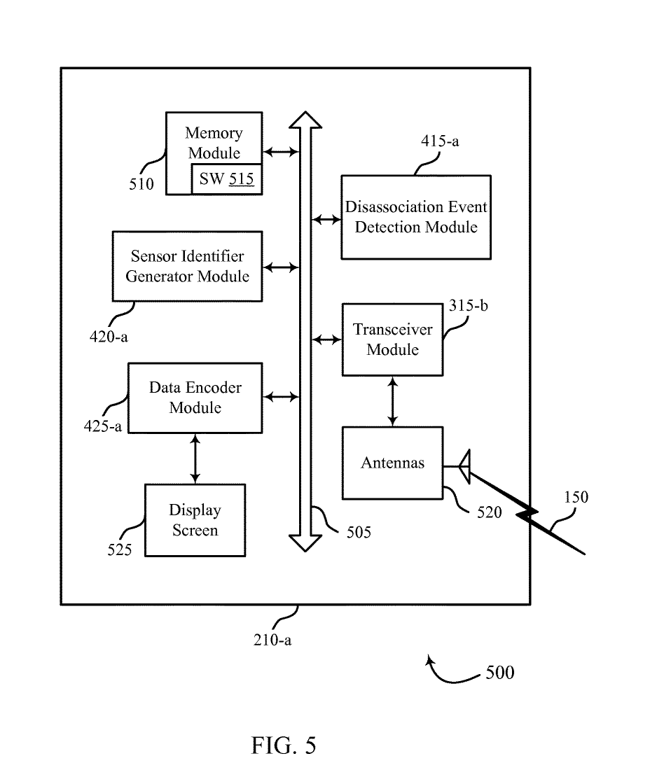

FIG. 5 shows a block diagram 500 of a display unit 210-a, which may be an example of display unit 210 described with reference to FIG. 2, in accordance with various aspects of the present disclosure. The display unit 210-a may, in some examples, have an internal power supply, such as a battery or other rechargeable cell to facilitate mobile operation. The display unit 210-a may also include a disassociation event detection module 415-a, a sensor identifier generator module 420-a, a data encoder module 425-a, and a transceiver module 315-b, which may be examples of one or more aspects of the disassociation event detection module 415, the sensor identifier generator module 420, the data encoder module 425, and the transceiver module 315-b described with reference to FIGS. 3-4. The display unit 210-a may be configured to implement at least some of the features and functions described with reference to FIGS. 1-4.

The disassociation event detection module 415-a, the sensor identifier generator module 420-a, the data encoder module 425-a, and the transceiver module 315-b may be in communication with each other, directly or indirectly, over one or more buses 505. The display unit 210-a may also include a memory module 510, which may include RAM and/or ROM. The memory module 510 may store computer-readable, computer-executable code (SW 515) containing instructions that are configured to, when executed, cause one or more of modules 415-a, 420-a, 425-a, and 315-b to perform various functions as described herein.

The transceiver module 315-b may be configured to communicate bi-directionally, via the antennas 520 and wireless communications link 150, with one or more local computing devices 115, 120 and/or a network 125 as described with reference to FIG. 1. The transceiver module 315-b may include a modem configured to modulate packets and provide the modulated packets to the antennas 520 for transmission, and to demodulate packets received from the antennas 520. The transceiver module 315-b may, in some examples, be implemented as one or more transmitter modules and one or more separate receiver modules.

The display unit 210-a may also include a display screen 525 operable to display a dynamically generated sensor identifier 220. The display screen 525 may be configured to display color images, monochrome images, barcodes, a sequence of barcodes or a dynamic barcode (e.g., to encode more information than can be encoded in a single, static barcode), static images, dynamic images, and/or blinking lights, and may be a touch screen. In some embodiments, the display screen 525 is an LCD screen or an LED screen.

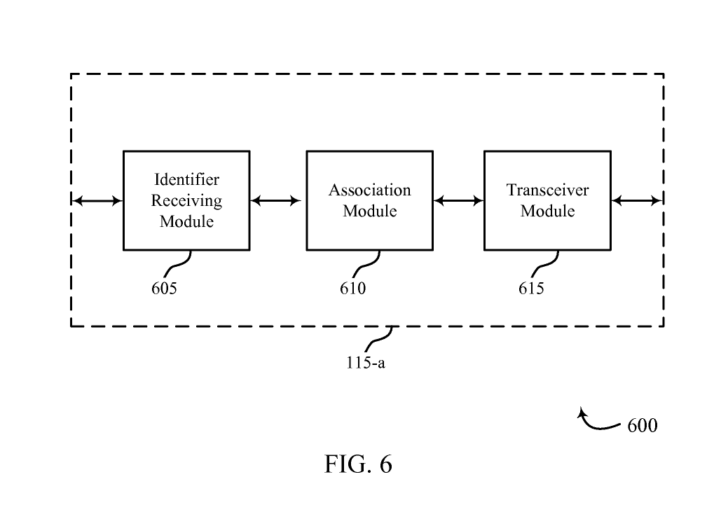

With reference to FIG. 6, a block diagram 600 of a local computing device 115-a, which may be an example of a local computing device 115 described with reference to FIG. 1, is illustrated in accordance with various embodiments of the present disclosure. In some examples, the local computing device 115-a includes an identifier receiving module 605, an association module 610, and a transceiver module 615. Each of these modules may be in direct or indirect communication with each other. In addition, the various modules of the local computing device 115-a may, individually or collectively, be implemented using one or more application-specific integrated circuits (ASICs) adapted to perform some or all of the applicable functions in hardware. Alternatively, the functions may be performed by one or more other processing units (or cores) such as a microcontroller, microprocessor or digital signal processor, on one or more integrated circuits. In other examples, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions embodied in a memory, formatted to be executed by one or more general or application-specific processors.

The identifier receiving module 605 may include circuitry, logic, hardware and/or software for scanning, recognizing, sensing, capturing or otherwise receiving an identifier such as a sensor identifier 220 or a patient identifier 230. The identifier receiving module 605 may include filters, analog-to-digital converters and other digital signal processing units. Data received and processed by the identifier receiving module may be stored in a buffer, for example. The identifier receiving module 605 may be operable to receive and process a variety of types of identifiers as described herein, including but not limited to, data from an optical sensor, a camera, an audio sensor, a radio frequency sensor, a magnetic sensor, a finger print reader, or a blood sample sensor. In some examples, the identifier receiving module 605 may be configured to receive and decode a sensor identifier 220 that is in the form of a machine-readable optical label. For example, the sensor identifier 220 may be in the form of a barcode or a blinking LED light. In other examples, the identifier receiving module 605 may receive a sensor identifier 220 that is transmitted via a near field communication (NFC) protocol or via an audio signal. Furthermore, the identifier receiving module 605 may be operable to receive and process a patient identifier 230 in the form of a machine-readable optical label, such as a barcode. In other examples, the identifier receiving module 605 may receive the patient identifier 230 in the form of a biometric identifier, such as a fingerprint, iris or retinal scan, facial recognition, voice recognition, DNA, or vein or palm print scan.

In some embodiments, the identifier receiving module 605 may be configured to receive and process data received by a sensor, such as sensor 240 of local computing device 115, to receive a sensor identifier 220 and a patient identifier 230. In accordance with various embodiments, the identifier receiving module 605 may be operable to receive a dynamically generated sensor identifier 220. The identifier receiving module 605 may then decode the received sensor identifier 220 and send the decoded information to the association module 610 and/or the transceiver module 615. For example, the unique identification of a particular sensor 205 encoded within the sensor identifier 220 may be decoded by the identifier receiving module 605 and sent to the association module 610 to associate the local computing device 115-a with a sensor unit 110 and/or a sensor 205. In addition, other information encoded within the sensor identifier 220, such as a power level of the sensor unit 110, a signal level of the sensor unit 110, wireless pairing information of the sensor unit 110, or collected medical data from the sensor 205 may be decoded by the identifier receiving module 605 and then sent to the transceiver module 615 for wireless transmission to any of another local computing device 115, 120, a central station 135, and/or a remote computing device 145. In some embodiments, the data received and processed by the identifier receiving module 605 may be stored in memory within local computing device 115-a for later retrieval.

The association module 610 may include circuitry, logic, hardware and/or software for associating a received sensor identifier 220 with a received patient identifier 230. The association between a particular sensor identifier 220 and a particular patient identifier 230 may be used to associate a particular sensor 205 with a particular patient 105. The association may be stored in memory within local computing device 115-a and/or sent to the transceiver module 615 for wireless transmission to any of another local computing device 115, 120, a central station 135, and/or a remote computing device 145. Once the association between a particular sensor identifier 220 and a particular patient identifier 230 is known, the medical data received from a particular sensor 205 may then be associated with a particular patient 105.

The transceiver module 615 may include circuitry, logic, hardware and/or software for sending data streams received from the association module 610 to one or more local computing devices 115, 120 or other remote computing devices 145 or central stations 135 via the network 125. For example, the transceiver module 615 may receive data streams from the association module 610 that indicate an association between a sensor identifier 220 and a patient identifier 230 and transmit this association to local computing devices 115, 120 or to a central station 135 via the network 125. The transceiver module 615 may include wired and/or wireless connectors. For example, in some embodiments, the transceiver module 615 may be a wireless network interface controller (“NIC”), Bluetooth® controller, IR communication controller, ZigBee® controller and/or the like.

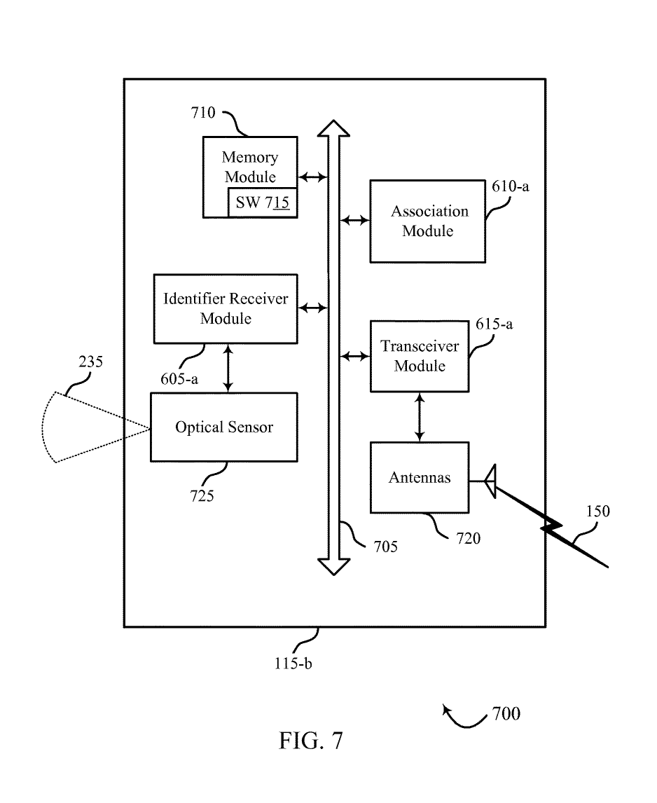

With reference to FIG. 7, a block diagram 700 of a local computing device 115-b, which may be an example of certain aspects of any local computing device 115, 120 described with reference to FIGS. 1-2 and/or 6, is illustrated in accordance with various embodiments of the present disclosure. The local computing device 115-b may have an internal power supply, such as a battery or other rechargeable cell to facilitate mobile operation. The local computing device 115-b may also include an identifier receiving module 605-a, an association module 610-a, and a transceiver module 615-a, which may be examples of the identifier receiving module 605, the association module 610, and the transceiver module 615 described with reference to FIG. 6. The local computing device 115-b may be configured to implement at least some of the features and functions described with reference to FIGS. 1-6.

The identifier receiving module 605-a, the association module 610-a, and the transceiver module 615-a may be in communication with each other, directly or indirectly, over one or more buses 705. The local computing device 115-b may also include a memory module 710, which may include RAM and/or ROM. The memory module 710 may store computer-readable, computer-executable code (SW 715) containing instructions that are configured to, when executed, cause one or more of modules 605-a, 610-a, and/or 615-a to perform various functions as described herein.

The local computing device 115-b may include an optical sensor 725 that is in communication with the identifier receiving module 605-a. In accordance with various embodiments, the optical sensor 725 is operable to receive 235 by scanning, photographing, or otherwise optically sensing or receiving a patient identifier 230 and a sensor identifier 220. For example, the optical sensor 725 may include or be an example of certain aspects of sensor 240 described with reference to FIG. 2. In some embodiments, the optical sensor 725 is a digital camera coupled with the local computing device 115-b. Alternatively, the optical sensor 725 may be a barcode reader or scanner such as an LED scanner, a laser scanner, or an omni-directional barcode scanner.

Once an identifier, such as a sensor identifier 220 or a patient identifier 230, is received via the optical sensor 725, the identifier is sent to the identifier receiving module 605-a to be decoded as described with reference to FIG. 6. The received sensor identifier 220 and patient identifier 230 may be stored within memory module 710. In accordance with various embodiments, the received sensor identifier 220 and patient identifier 230 are sent to the association module 610-a, which may be configured to associate the sensor identifier 220 with the patient identifier 230. This association may then be sent to the memory module 710 and/or may be transmitted by the transceiver module 615-a, via one or more antennas 720 and wireless communications links 150, to another local computing device 115, 120, a central station 135, or a remote database 140 via network 125, as described with reference to FIG. 1.

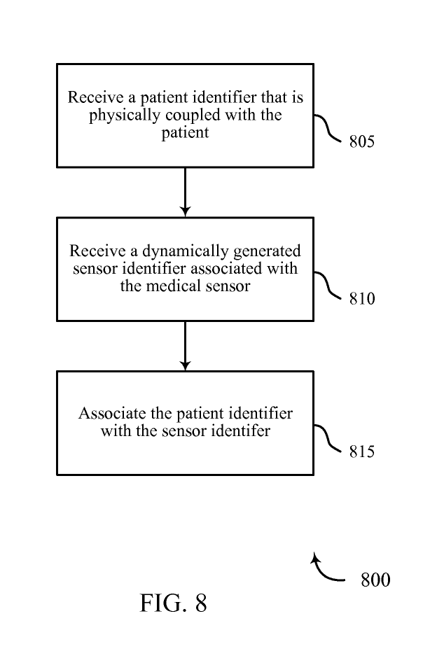

FIG. 8 is a flow chart illustrating an example of a method 800 for associating a patient with a medical sensor. For clarity, the method 800 is described below with reference to aspects of one or more of the sensor unit 110, the local computing devices 115, 120, the remote computing device 145, and/or the central station 135 described with reference to FIGS. 1-7. In some examples, a local computing device, remote computing device or central station such as one of the local computing devices 115, 120, remote computing device 145, central station 135 and/or an apparatus such as one of the sensor units 110 or display units 210 may execute one or more sets of codes to control the functional elements of the local computing device, remote computing device, central station or apparatus to perform the functions described below.

At block 805, the method 800 may include receiving a patient identifier that is physically coupled with a patient. In accordance with various embodiments, any of local computing devices 115, 120, remote computing devices 145, central station 135 and/or any of their modules or components may receive a patient identifier 230 that is physically coupled with a patient 105. For example, sensor 240 or optical sensor 725 of FIGS. 4 and 7 may be configured to receive a patient identifier 230. In some examples, the patient identifier 230 is a static machine-readable optical label, such as a barcode printed on a band 225 worn by the patient 105. In other examples, the patient identifier 230 may include a biometric identifier of the patient 105.

At block 810, the method 800 may include receiving a dynamically generated sensor identifier associated with the medical sensor. Similar to block 805, any of local computing devices 115, 120, remote computing devices 145, central station 135 and/or any of their modules or components may receive a dynamically generated sensor identifier 220 that is associated with a particular sensor 205. For example, sensor 240 or optical sensor 725 of FIGS. 4 and 7 may be configured to receive a dynamically generated sensor identifier 220 that is associated with a medical sensor 205. With reference to FIG. 2, the dynamically generated sensor identifier 220 may be a machine-readable optical label, such as a QR barcode, that is displayed from a display unit 210. As described with reference to FIG. 4, the sensor identifier 220 may be generated by a sensor identifier generator module 420 and may be updated or otherwise changed in response to a disassociation event.

At block 815, the method 800 may include associating the patient identifier with the sensor identifier. In accordance with various embodiments, any of local computing devices 115, 120, central station 135, or remote computing devices 145 and/or their associated modules or components, may associate a patient identifier 230 with a sensor identifier 220 to thereby associate a particular patient 105 with a particular sensor 205. With reference to FIG. 6, association module 610 may be configured to associate a patient identifier 230 with a sensor identifier 220 in some examples.

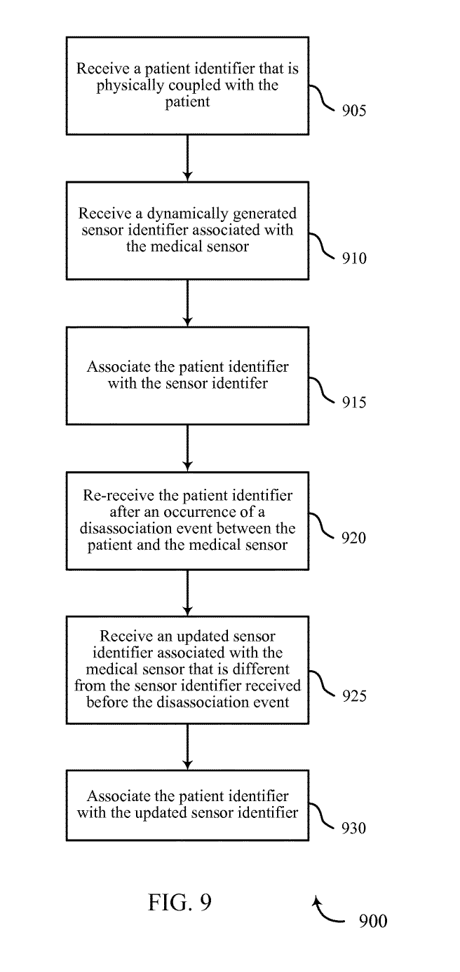

FIG. 9 is a flow chart of a method 900 for associating a patient with a medical sensor. For clarity, the method 900 is described below with reference to aspects of one or more of the sensor unit 110, the local computing devices 115, 120, the remote computing device 145, and/or the central station 135 described with reference to FIGS. 1-7. In some examples, a local computing device, remote computing device, or central station such as one of the local computing devices 115, 120, remote computing device 145, central station 135 and/or an apparatus such as one of the sensor units 110 or display units 210 may execute one or more sets of codes to control the functional elements of the local computing device, remote computing device, central station 135 or apparatus to perform the functions described below.

Method 900 may include, at block 905, receiving a patient identifier that is physically coupled with the patient, and at block 910, receiving a dynamically generated sensor identifier associated with the medical sensor. Similar to the methods described with reference to blocks 805 and 810, the methods of blocks 905 and 910 may be carried out by one or more of the local computing devices 115, 120, the remote computing device 145, the central station 135, and/or any of their associated modules or components, as described with reference to FIGS. 1-7. Method 900 may also include, at block 915, associating the patient identifier with the sensor identifier. As described with reference to block 815, any of local computing devices 115, 120, central station 135, or remote computing devices 145 and/or their associated modules or components, may associate a patient identifier 230 with a sensor identifier 220 to thereby associate a particular patient 105 with a particular sensor 205.

At block 920, method 900 may include re-receiving the patient identifier after an occurrence of a disassociation event between the patient and the medical sensor. In some examples, any of local computing devices 115, 120, central station 135, or remote computing devices 145 and/or their associated modules or components, may re-receive a patient identifier 230 after an occurrence of a disassociation event between a patient 105 and a medical sensor 205. With reference to FIG. 4, a disassociation event detection module 415 may detect a disassociation event and send this information to one or more modules or components of a sensor unit 110-c.

At block 925, method 900 may include receiving an updated sensor identifier associated with the medical sensor that is different from the sensor identifier received before the disassociation event. As described with reference to FIGS. 1-2 and 6-7, any of local computing devices 115, 120, central station 135, or remote computing devices 145 and/or their associated modules or components, may receive an updated sensor identifier 220 associated with a medical sensor 205 that is different from the sensor identifier 220 received before the disassociation event. In some examples, the sensor identifier generator module 420 described with reference to FIG. 4 may generate a sensor identifier 220 after a disassociation event that is different from the sensor identifier 220 received before the disassociation event.

At block 930, method 900 may include associating the patient identifier with the updated sensor identifier. In accordance with various embodiments, any of local computing devices 115, 120, central station 135, or remote computing devices 145 and/or their associated modules or components, may associate the patient identifier 230 with the updated sensor identifier 220. Referring to FIG. 6, an association module 610 of local computing device 115-c may associate the patient identifier 230 with the updated sensor identifier 220 to thereby associate a particular patient 105 with a particular sensor 205.

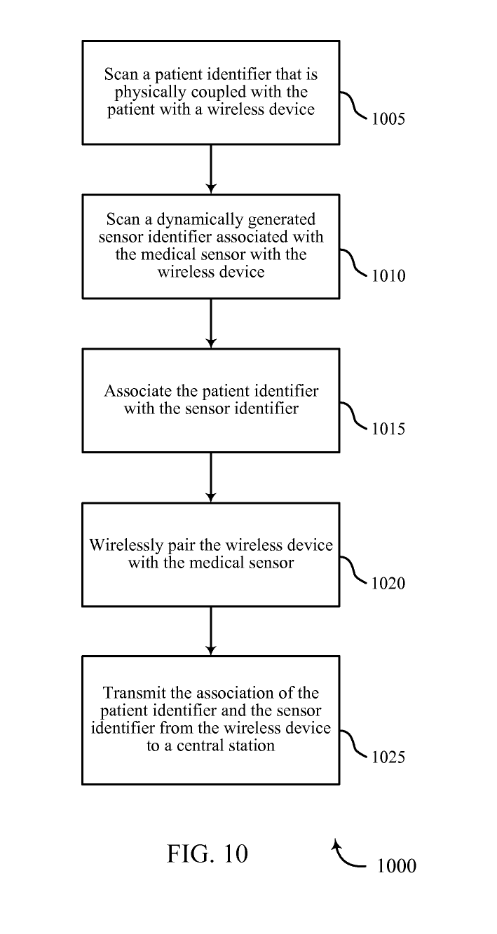

FIG. 10 is a flow chart illustrating an example of a method 1000 for associating a patient with a medical sensor. For clarity, the method 1000 is described below with reference to aspects of one or more of the sensor unit 110, the local computing devices 115, 120, the remote computing device 145, and/or the central station 135 described with reference to FIGS. 1-7. In some examples, a local computing device, remote computing device or central station such as one of the local computing devices 115, 120, remote computing device 145, central station 135 and/or an apparatus such as one of the sensor units 110 or display units 210 may execute one or more sets of codes to control the functional elements of the local computing device, remote computing device, central station or apparatus to perform the functions described below.

At block 1005, method 1000 may include scanning a patient identifier that is physically coupled with the patient with a wireless device. As described with reference to FIGS. 1-2 and 6-7, any of local computing devices 115, 120 or remote computing devices 145 and/or their associated modules or components may scan a patient identifier 230 that is physically coupled with a patient 105. For example, with reference to FIGS. 4 and 7, sensor 240 and/or optical sensor 725 may scan a patient identifier 230 that is coupled with a patient 105.

At block 1010, method 1000 may include scanning a dynamically generated sensor identifier associated with the medical sensor with the wireless device. Similar to block 1005, any of local computing devices 115, 120 or remote computing devices 145 and/or their associated modules or components may be configured to scan a dynamically generated sensor identifier 220 associated with a medical sensor 205. For example, with reference to FIGS. 4 and 7, sensor 240 and/or optical sensor 725 may scan a dynamically generated sensor identifier 220 associated with a medical sensor 205.

At block 1015, method 1000 may include associating the patient identifier with the sensor identifier. In some examples, any of local computing devices 115, 120, central station 135, or remote computing devices 145 and/or their associated modules or components, may associate a patient identifier 230 with a sensor identifier 220. With reference to FIG. 6, association module 610 may be operable to associate a received patient identifier 230 with a received sensor identifier 220.

At block 1020, method 1000 may include wirelessly pairing the wireless device with the medical sensor. Referring to FIGS. 1-2, any of local computing devices 115, 120 or remote computing devices 145 may wirelessly pair with the sensor unit 110 and/or sensor 205. Wireless pairing information may be encoded within the sensor identifier 220 by a data encoder module 425, as described with reference to FIGS. 3-5.

At block 1025, method 1000 may include transmitting the association of the patient identifier and the sensor identifier from the wireless device to a central station. In some examples, a local computing device 115, 120 may transmit an association of a patient identifier 230 and a sensor identifier 220 to a central station 135 and/or a remote database 140 via a network 125, as described with reference to FIG. 1.

The above description provides examples, and is not limiting of the scope, applicability, or configuration set forth in the claims. Changes may be made in the function and arrangement of elements discussed without departing from the spirit and scope of the disclosure. Various embodiments may omit, substitute, or add various procedures or components as appropriate. For instance, the methods described may be performed in an order different from that described, and various steps may be added, omitted, or combined. Also, features described with respect to certain embodiments may be combined in other embodiments.

The detailed description set forth above in connection with the appended drawings describes exemplary embodiments and does not represent the only embodiments that may be implemented or that are within the scope of the claims. The term “exemplary” used throughout this description means “serving as an example, instance, or illustration,” and not “preferred” or “advantageous over other embodiments.” The detailed description includes specific details for the purpose of providing an understanding of the described techniques. These techniques, however, may be practiced without these specific details. In some instances, well-known structures and devices are shown in block diagram form in order to avoid obscuring the concepts of the described embodiments.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration. A processor may in some cases be in electronic communication with a memory, where the memory stores instructions that are executable by the processor.

The functions described herein may be implemented in hardware, software executed by a processor, firmware, or any combination thereof. If implemented in software executed by a processor, the functions may be stored on or transmitted over as one or more instructions or code on a computer-readable medium. In some embodiments, a sensor unit 110, or any associated subcomponents or modules, may download firmware or software or a high level scripting language or configuration data from a network 125 which provides specific operating parameters for that network. In other embodiments, the a sensor unit 110 may upload firmware or software or a high level scripting language or configuration data to the network 125 explaining how it may be used on a network 125. Other examples and implementations are within the scope and spirit of the disclosure and appended claims. For example, due to the nature of software, functions described above may be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items indicates a disjunctive list such that, for example, a list of “at least one of A, B, or C” means A or B or C or AB or AC or BC or ABC (i.e., A and B and C).

A computer program product or computer-readable medium both include a computer-readable storage medium and communication medium, including any mediums that facilitates transfer of a computer program from one place to another. A storage medium may be any medium that may be accessed by a general purpose or special purpose computer. By way of example, and not limitation, computer-readable medium may comprise RAM, ROM, EEPROM, CD-ROM or other optical disk storage, magnetic disk storage or other magnetic storage devices, or any other medium that may be used to carry or store desired computer-readable program code in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote light source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and blu-ray disc where disks usually reproduce data magnetically, while discs reproduce data optically with lasers. Combinations of the above are also included within the scope of computer-readable media.

The previous description of the disclosure is provided to enable a user skilled in the art to make or use the disclosure. Various modifications to the disclosure will be readily apparent to those skilled in the art, and the generic principles defined herein may be applied to other variations without departing from the spirit or scope of the disclosure. Throughout this disclosure the term “example” or “exemplary” indicates an example or instance and does not imply or require any preference for the noted example. Thus, the disclosure is not to be limited to the examples and designs described herein but is to be accorded the widest scope consistent with the principles and novel features disclosed herein.

1. A method for associating a patient with a medical sensor, comprising:
receiving a patient identifier that is physically coupled with the patient;
receiving a dynamically generated sensor identifier associated with the medical sensor; and
associating the patient identifier with the sensor identifier.

2. The method of claim 1, further comprising:
re-receiving the patient identifier after an occurrence of a disassociation event between the patient and the medical sensor;
receiving an updated sensor identifier associated with the medical sensor that is different from the sensor identifier received before the disassociation event; and
associating the patient identifier with the updated sensor identifier.

3. The method of claim 2, wherein the disassociation event comprises any of:
a power level of the medical sensor dropping below a predetermined threshold, a signal level of the medical sensor dropping below a predetermined threshold, the medical sensor being physically removed from the patient, or pressing one or more buttons on the medical sensor to disassociate the medical sensor from the patient.

4. The method of claim 1, wherein the sensor identifier comprises a machine-readable optical label.

5. The method of claim 4, wherein the machine-readable optical label comprises a quick-response (QR) barcode.

6. The method of claim 1, wherein the patient identifier comprises a machine-readable optical label worn by the patient.

7. The method of claim 1, wherein the patient identifier comprises a biometric identifier of the patient.

8. The method of claim 1, wherein receiving the patient identifier and receiving the sensor identifier comprises scanning the patient identifier and the sensor identifier with a wireless device.

9. The method of claim 8, further comprising wirelessly pairing the wireless device with the medical sensor.

10. The method of claim 8, further comprising transmitting the association of the patient identifier and the sensor identifier from the wireless device to a central station.

11. The method of claim 1, further comprising receiving sensed data from the medical sensor.

12. The method of claim 1, wherein the medical sensor is a wireless medical sensor.

13. The method of claim 1, wherein the medical sensor is a pulse oximeter.

14. A system for associating a patient with a medical sensor, comprising:
a medical sensor configured to collect medical data from the patient; and
a display unit coupled with the medical sensor and configured to display a dynamically generated sensor identifier associated with the medical sensor.

15. The system of claim 14, further comprising a wireless device configured to scan the sensor identifier and wirelessly pair with the medical sensor.

16. The system of claim 14, wherein the display unit is further configured to automatically generate an updated sensor identifier upon an occurrence of a disassociation event between the patient and the medical sensor.

17. The system of claim 16, wherein the disassociation event comprises any of:
a power level of the medical sensor dropping below a predetermined threshold, a signal level of the medical sensor dropping below a predetermined threshold, the medical sensor being physically removed from the patient, or pressing one or more buttons on the medical sensor to disassociate the medical sensor from the patient.

18. The system of claim 14, wherein the sensor identifier comprises a machine-readable optical label.

19. The system of claim 18, wherein the machine-readable optical label is configured to encode any of:
a signal strength of the medical sensor, a power level of the medical sensor, wireless pairing information of the medical sensor, or a total number of medical sensors coupled with the patient.

20. The system of claim 18, wherein the machine-readable optical label is configured to encode the medical data being collected from the patient.

21. The system of claim 20, wherein the encoded medical data comprises any of:
a current reading of the collected medical data, a recent maximum value of the collected medical data, a recent minimum value of the collected medical data, or a recent trend of the collected medical data.

22. The system of claim 14, wherein the display unit comprises a liquid crystal display (LCD) screen.

23. The system of claim 14, wherein the display unit comprises a light-emitting diode (LED) display.

24. The system of claim 14, wherein the display unit is further configured to display the sensor identifier only after the medical sensor is physically coupled with the patient.

25. The system of claim 14, further comprising one or more additional medical sensors coupled with the display unit.

26. The system of claim 25, wherein the display unit is further configured to display a unique dynamically generated sensor identifier for each of the one or more additional medical sensors.

27. An apparatus for associating a patient with a medical sensor, comprising:
a processor;
memory in electronic communication with the processor; and
instructions stored in the memory and operable, when executed by the processor, to cause the apparatus to:
dynamically generate a sensor identifier associated with the medical sensor.

28. The apparatus of claim 27, wherein the instructions are operable to cause the processor to automatically generate an updated sensor identifier upon an occurrence of a disassociation event between the patient and the medical sensor.

29. The apparatus of claim 27, wherein the instructions are operable to cause the processor to generate the sensor identifier only after the medical sensor is physically coupled with the patient.

30. The apparatus of claim 27, wherein the instructions are operable to cause the processor to encode into the sensor identifier any of:
a signal strength of the medical sensor, a power level of the medical sensor, or wireless pairing information of the medical sensor.
